(19) United States
(12) Patent Application Publication
(10) Pub. No.: US 2023/0306130 A1
(43) Pub. Date: Sep. 28, 2023

(54) INFORMATION PROCESSING SYSTEM, INFORMATION PROCESSING METHOD, AND PROGRAM RECORDING MEDIUM

(71) Applicant: NEC Corporation, Minato-ku, Tokyo (JP)

(72) Inventors: Takayuki SASAKI, Tokyo (JP); Nobuyuki TOZAWA, Tokyo (JP); Tetsuya TANABKI, Tokyo (JP); Yasuhiko OCHIAI, Tokyo (JP); Ayumi NISHIJIMA, Tokyo (JP); Naoki SUGAYA, Tokyo (JP); Kazuki OGATA, Tokyo (JP); Hiroaki AMINAKA, Tokyo (JP); Kei YANAGISAWA, Tokyo (JP); Kosei KOBAYASHI, Tokyo (JP)

(73) Assignee: NEC Corporation, Minato-ku, Tokyo (JP)

(21) Appl. No.: 18/023,633

(22) PCT Filed: Sep. 2, 2020
(86) PCT No.: PCT/JP2020/033185

§ 371 Date: Feb. 27, 2023

(51) Int. Cl. G06F 21/62; G06V 20/40; G06V 20/54

(52) U.S. Cl. CPC G06F 21/6227; G06V 20/44; G06V 20/54; G06F 2221/2141

(57) ABSTRACT

An information processing system includes an event analyzer that detects an occurrence of an event on a basis of data measured by a predetermined sensor; a storage that stores a security policy that defines a user attribute allowed to access to each type of the event; and an access controller that controls whether or not an access from a user to data on which the event is occurring is permitted on a basis of the security policy.

### TECHNICAL FIELD

The present invention relates to an information processing system, information processing method, and program recording medium.

### BACKGROUND

In order to prevent crimes, achieve road traffic safety, and streamline urban management, cities have sensors (including cameras) installed in many places. The information collected from these sensors and cameras is expected to be utilized in various ways such as being displayed on the Internet and/or on information terminals on the street.

Patent Literature 1 discloses a security camera system that claims to contribute to the prevention of incidents and accidents without the need for human intervention by effectively utilizing videos recorded by security cameras installed in various locations. According to Patent Literature 1, the security camera system is provided with storage means for storing one or more pieces of reference video information for detecting an occurrence of one or more predetermined events and receiving means for receiving the video information from each of one or more of the security camera devices. The security camera system compares the video information received through the receiving means with each of one or more pieces of the reference video information stored in the storage means and detects an occurrence of the predetermined event in the vicinity of the security camera device. If occurrence of any of the one or more predetermined events is detected, the security camera system executes a process determined according to the detected event. Patent Literature 1 further states that, as the process determined according to the detected event, the occurrence of the event is notified to a predetermined entity or a detection target is tracked.

Patent Literature 2 discloses an event management system that claims to be able to notify an occurrence of an event quickly and clearly to an appropriate browser terminal, without overloading the network traffic. According to Patent Literature 2, the event management system detects an event in captured video and assigns an identifier to the event. When receiving from a browser terminal an event video request signal including the event identifier for the selected event, the event management system extracts the event video data corresponding to each event identifier transmitted from the browser terminal. Then, the event management system transmits the event video data extracted by event video extraction means to the applicable browser terminal.

Patent Literature 3 discloses an in-vehicle video recording apparatus that claims to be able to prevent recorded video from being falsified or deleted. According to Patent Literature 3, the in-vehicle video recording apparatus determines that an event related to a change in vehicle behavior has occurred when the magnitude of a physical quantity representing a change in vehicle behavior outputted from a sensor that measures the physical quantity exceeds a first threshold and stores a video containing an image capturing the occurrence of the event in a first storage part with unrestricted access and a second storage part with limited access.

### CITATION LIST

### Patent Literature

[Patent Literature 1] Japanese Patent Application Publication No. JP2011-215767A
[Patent Literature 2] Japanese Patent Application Publication No. JP2008-154100A
[Patent Literature 3] Japanese Patent Application Publication No. JP2020-004223A

### SUMMARY

### Technical Problem

The following analysis is given by the present inventor. Most of the information obtained by the cameras and sensors described above is assumed to be viewed by only a specific person according to the installation purpose (refer to Patent Literature 1, for example). Meanwhile, the information obtained by these sensors (including cameras) may contain useful information unrelated to the purpose of installing the cameras and sensors. For example, from road surface information captured by a roadside camera for enforcing traffic laws, it is possible to know whether it is raining there. It may also be possible to analyze a people flow in shopping streets from video information obtained by security cameras. Thus, cameras and sensors installed in various places have unutilized value.

Unconditional disclosure of information obtained from these sensors is likely to lead to privacy and security issues. One measure could be to give appropriate access rights to users with various attributes with respect to information obtained by these sensors.

However, there is a problem that it is time-consuming to write detailed access control policies when trying to give appropriate access rights to users with various attributes. In this respect, in the Patent Literature 1, while the police, fire service, security companies and contractors are expected as notified parties, it does not mention to set detailed differences in the data to which these parties have access. Further, Patent Literature 2 only describes that each camera is linked to a notification destination browser terminal ID to change data destinations (refer to FIG. 5 of Patent Literature 2).

It is an object of the present invention to provide an information processing system, information processing method, and program that can contribute to promoting a utilization of a large amount of information obtained by the sensors (including cameras) described above.

### Solution to Problem

According to a first aspect, there is provided an information processing system, comprising: means for detecting an occurrence of an event on a basis of data measured by a predetermined sensor;

means for storing a security policy that defines a user attribute allowed to access to each type of the event; and

means for controlling whether or not an access from a user to data on which the event is occurring is permitted on a basis of the security policy.

According to a second aspect, there is provided an information processing method of an information processing system including a security policy storage part storing a security policy that defines a user attribute allowed to access to each type of an event and a control part, the information processing method, comprising:

detecting an occurrence of the event on a basis of data measured by a predetermined sensor; and

controlling whether or not an access from a user to data on which the event is occurring is permitted on a basis of the security policy. The present method is associated with a certain machine referred to as the information processing system provided with the security policy storage part and the control part.

According to a third aspect, there is provided a program causing a computer comprising a security policy storage part storing a security policy that defines a user attribute allowed to access to each type of an event and a control part to execute:

a process of detecting an occurrence of the event on a basis of data measured by a predetermined sensor; and

a process of controlling whether or not an access from a user to data on which the event is occurring is permitted on a basis of the security policy.

This program is supplied to a computer apparatus using an input device or from an outside via a communication interface, is stored in a storage device, and operates a processor according to predetermined steps or processes. Further, this program can display processing results thereof including an intermediate state as necessary via a display device step by step or can communicate with the outside via the communication interface. For example, the computer apparatus for this purpose is typically provided with a processor, a storage device, an input device, a communication interface and a display device as needed, which can be connected to each other via a bus. In addition, this program can be recorded in a computer-readable (non-transitory) storage medium.

### Advantageous Effects of Invention

According to the present invention, there are provided an information processing system, information processing method, and program that can promote a utilization of a large amount of information obtained by a sensor (including a camera).

### BRIEF DESCRIPTION OF DRAWINGS

FIG. 1 is a drawing illustrating a configuration of an example embodiment of a present invention.

FIG. 2 is a drawing illustrating a configuration of an information processing system according to a first example embodiment of the present invention.

FIG. 3 is a drawing showing an example of data stored in a data storage part of the information processing system according to the first example embodiment of the present invention.

FIG. 4 is a drawing showing an example of a security policy used in the first example embodiment of the present invention.

FIG. 5 is a flowchart showing an operation (data storage) of the information processing system according to the first example embodiment of the present invention.

FIG. 6 is a flowchart showing an operation (access control) of the information processing system according to the first example embodiment of the present invention.

FIG. 7 is a drawing illustrating an example of access control performed by the information processing system according to the first example embodiment of the present invention.

FIG. 8 is a drawing showing an example of data stored in a data storage part of an information processing system according to a second example embodiment of the present invention.

FIG. 9 is a drawing illustrating an example of a form of providing data by the information processing system according to the second example embodiment of the present invention.

FIG. 10 is a drawing illustrating a configuration of an information processing system according to a third example embodiment of the present invention.

FIG. 11 is a drawing showing an example of data stored in a data storage part of the information processing system according to the third example embodiment of the present invention.

FIG. 12 is a flowchart showing an operation (data storage) of the information processing system according to the third example embodiment of the present invention.

FIG. 13 is a flowchart showing an operation (access control) of the information processing system according to the third example embodiment of the present invention.

FIG. 14 is a drawing showing an example of a security policy used in a fourth example embodiment of the present invention.

FIG. 15 is a drawing illustrating a configuration of an information processing system according to a fifth example embodiment of the present invention.

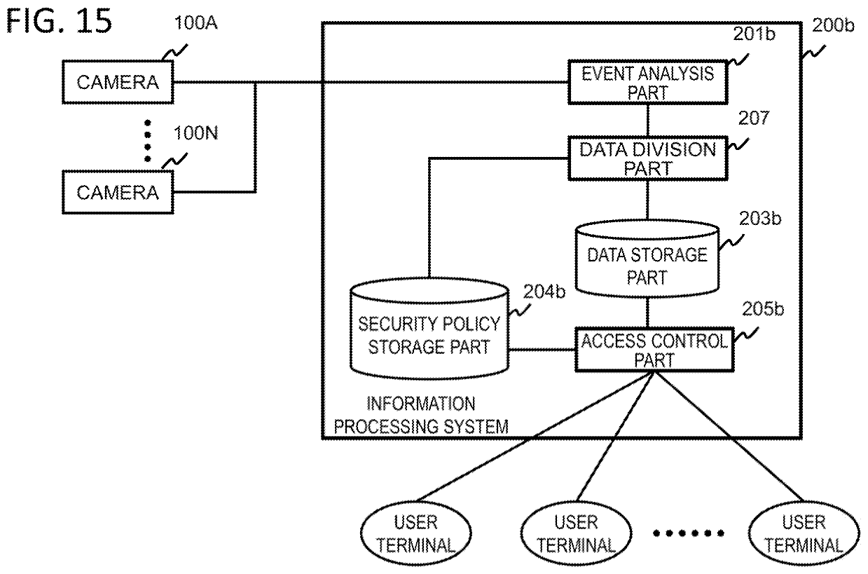

FIG. 16 is a drawing showing an example of a security policy used in the fifth example embodiment of the present invention.

FIG. 17 is a drawing showing an example of data stored in a data storage part of the information processing system according to the fifth example embodiment of the present invention.

FIG. 18 is a drawing illustrating an example of access control performed by the information processing system according to the fifth example embodiment of the present invention.

FIG. 19 is a drawing showing an example of a security policy used in a sixth example embodiment of the present invention.

FIG. 20 is a flowchart showing an operation (access control) of the information processing system according to the sixth example embodiment of the present invention.

FIG. 21 is a flowchart showing an operation (data storage and push notification) of an information processing system according to a seventh example embodiment of the present invention.

FIG. 22 is a drawing illustrating a configuration of a computer configuring an information processing system of the present invention.

### EXAMPLE EMBODIMENTS

First, an outline of an example embodiment of the present invention will be given with reference to drawings. It should be noted that drawing reference signs in the outline are given to each element for convenience as an example to facilitate understanding and are not intended to limit the present invention to the illustrated modes. Further, connection lines between blocks in the drawings referred to in the following description can be both bidirectional and unidirectional. A unidirectional arrow schematically shows the main flow of a signal (data) and does not exclude bidirectionality. A program is executed by a computer apparatus, and the computer apparatus is provided with, for example, a processor, a storage device, an input device, a communication interface, and a display device as needed. Further, the computer apparatus is configured to be able to perform wired or wireless communication with an internal device therein or with an external device (including a computer) via the communication interface. Although input/output connection points of each block in the drawings have ports or interfaces, these are not illustrated. Further, in the following description, “A and/or B” means at least one of A and B.

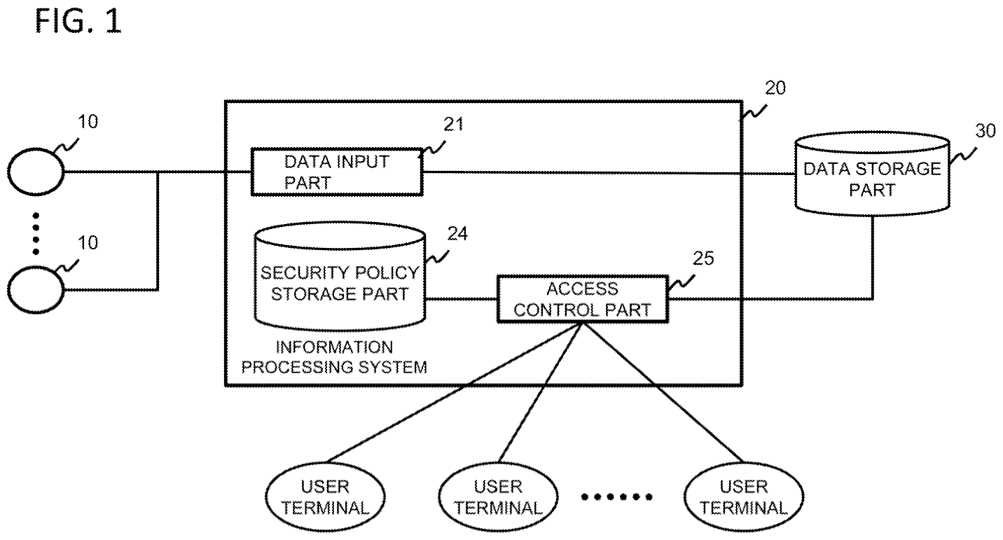

As shown in FIG. 1, an example embodiment of the present invention can be realized by a data input part 21, a security policy storage part 24, an access control part 25, and an information processing system 20. More concretely, the data input part 21 is connected to one or more sensors 10 and functions as means for detecting an occurrence of an event on a basis of data measured by the sensors 10.

Here, the sensor 10 may be a security camera, traffic flow (people flow) measurement camera, or a camera mounted on a vehicle and/or a robot. In addition to a camera, the sensor 10 may be a sensor and/or various measuring devices installed in the transportation infrastructure to measure traffic-related data. For example, if the sensor 10 is a security camera, the data input part 21 detects that a suspicious person has been captured on the security camera and detects an event named suspicious person detected.” Further, if the sensor 10 is a traffic counter that measures a traffic volume, the data input part 21 detects that the traffic volume at a particular point measured by the traffic counter exceeds a threshold value and detects an event named “traffic volume predetermined value exceeded.”

The security policy storage part 24 functions as means for storing a security policy that defines a user attribute allowed to access to each type of the event. For example, the security policy is configured to include an entry specifying a user attribute allowed to access the event of “suspicious person detected” or “traffic volume predetermined value exceeded.”

A data storage part 30 stores data measured by the sensor 10 therein. In the example shown in FIG. 1, it shows a form in which data after an occurrence of an event is detected at the data input part 21 is recorded therein, however, it may be a form in which data measured by the sensor 10 is directly recorded in the data storage part 30. In this case, means that corresponds to the data input part 21 may access the data storage part 30, obtain newly added data, and detect an occurrence of an event.

The access control part 25 functions as means for controlling whether or not an access from a user (or a user terminal) to data on which the event is occurring is permitted on a basis of the security policy. For example, the access control part 25 receives access requests from a user terminal to data which specifies a type of an event among data recorded in the data storage part 30. In this case, the access control part 25 determines the attribute of the user from an ID of the user terminal and other information, and performs a control to allow a user to access to a relevant type of the event, if the user is permitted to access thereto in the security policy described above. On the other hand, if the user is not permitted to access to the relevant type of the event in the security policy, the access control part 25 performs a control to deny the user to access.

According to the present example embodiment that operates as described above, it becomes possible to appropriately grant access right to a large amount of information obtained by sensors (including cameras) and promptly provide the information.

### First Example Embodiment

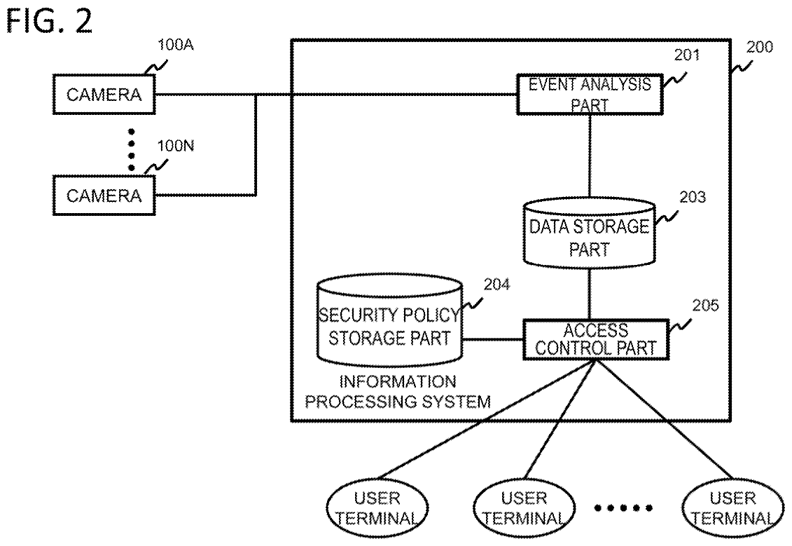

Next, a first example embodiment of the present invention will be described in detail with reference to drawings. FIG. 2 is a drawing illustrating a configuration of an information processing system according to the first example embodiment of the present invention. FIG. 2 shows an information processing system 200 is provided with an event analysis part 201, a data storage part 203, a security policy storage part 204, and an access control part 205.

The information processing system 200 is described as containing a plurality of cameras 100A to 100N installed on the roadside and connected thereto as sensors. In the following description, cameras 100A to 100N are described as transmitting image data captured at predetermined time intervals to the information processing system 200. Note that sensors other than cameras may be connected to the information processing system 200 as the sensors.

When receiving image data captured by the cameras 100A to 100N, the event analysis part 201 analyzes the image data and detects an occurrence of a specific event. After detecting the occurrence of the event, the event analysis part 201 stores the inputted image data in association with a type of the detected event in the data storage part 203. Note that image data in which no event is detected may be discarded or may be stored in the data storage part 203 for a certain period of time. Whether or not image data in which no event is detected should be stored may be determined according to a purpose of recording the image data or the attribute of the user allowed to access the image data. Further, the event detection and the identification of the type thereof can be achieved by recognizing objects in the image or using classifiers created by using machine learning.

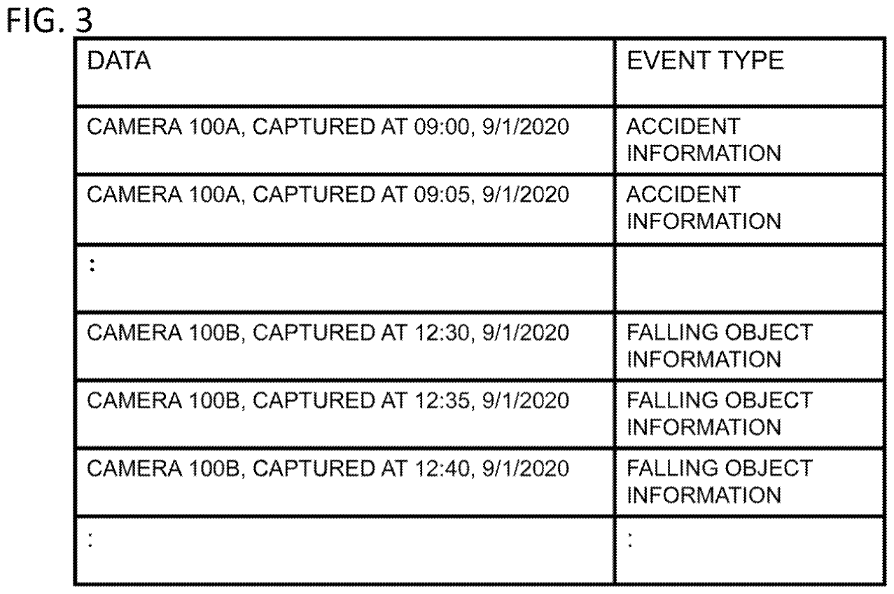

The data storage part 203 stores image data captured by the cameras 100A to 100N in association with the type of a detected event. FIG. 3 is a drawing showing an example of data stored in the data storage part 203 of the information processing system according to the first example embodiment of the present invention. In the example in FIG. 3, of image data captured every five minutes by cameras 100A to 100N, the image data for which the event analysis part 201 has determined that an event has occurred are assigned an event type and stored. Note that, although the example of FIG. 3 shows two event types: accident (information) and falling object (information), the event types are not limited to these two. Further, the event types may be subdivided into more detailed categories. For example, the accident (information) and the falling object (information) may be subdivided by a type of accident (for example, vehicle-to-vehicle, vehicle-to-pedestrian, etc.) and by a size and number of falling objects, respectively.

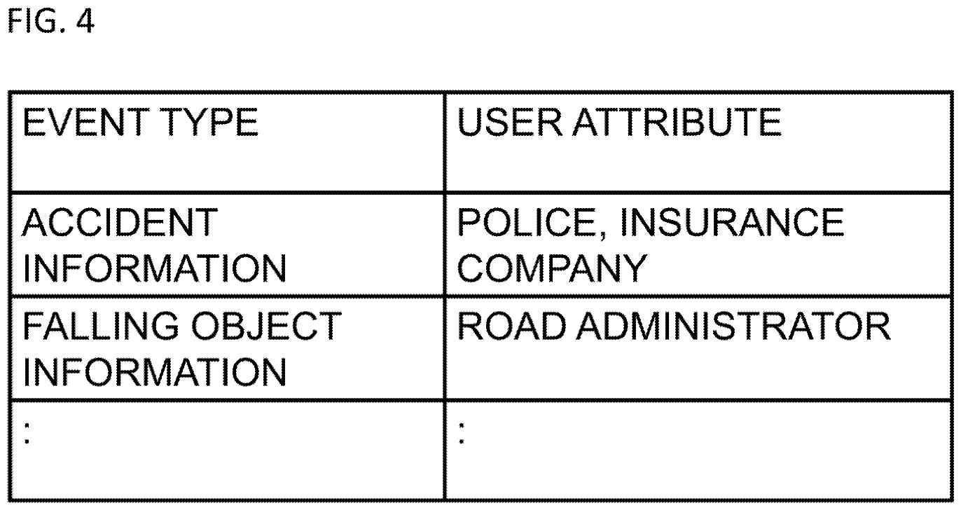

The security policy storage part 204 stores a security policy that defines a user attribute allowed to access to each type of event. FIG. 4 is a drawing showing an example of a security policy used in the first example embodiment of the present invention. In the example of FIG. 4, for each type of event (event type), a user attribute allowed to access to the image data of the relevant event type is defined. Note that, although the example of FIG. 4 shows three user attributes: which are police, an insurance company, and a road administrator, user attributes allowed to access are not limited to this example. For example, access authority may be given to navigation information providers, logistics service providers, local governments, etc. Also, the user attributes may be described differently from the example shown in FIG. 4. For example, the user attribute for the police may be defined so that access authority is given only to traffic control personnel and incident investigators, instead of giving the access authority to all police officers.

The access control part 205 receives from a user terminal an access request specifying an event type with respect to data stored in the data storage part 203. The access control part 205 then refers to the security policy and controls access to the requested data depending on whether or not the relevant user terminal has an access right.

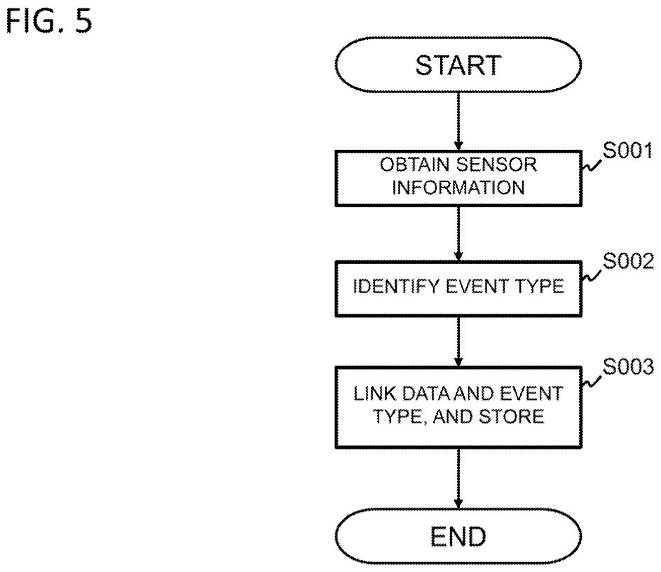

Next, an operation of the present example embodiment will be described in detail with reference to drawings. FIG. 5 is a flowchart showing an operation (data storage) of the information processing system according to the first example embodiment of the present invention. With reference to FIG. 5, when the information processing system 200 obtains image data from one of the cameras 100A to 100N as sensor information (step S001), it analyzes the image data and identifies a type of an event that has occurred (step S002).

When the event type can be determined, the information processing system 200 links the image data to the event type and stores them in the data storage part 203 (step S003). By repeating the above operations, data, each of which is linked to an event type, are accumulated in the data storage part 203, as shown in FIG. 3. Note that the data stored in the data storage part 203 may be deleted according to a certain rule such as an elapse of a predetermined time period.

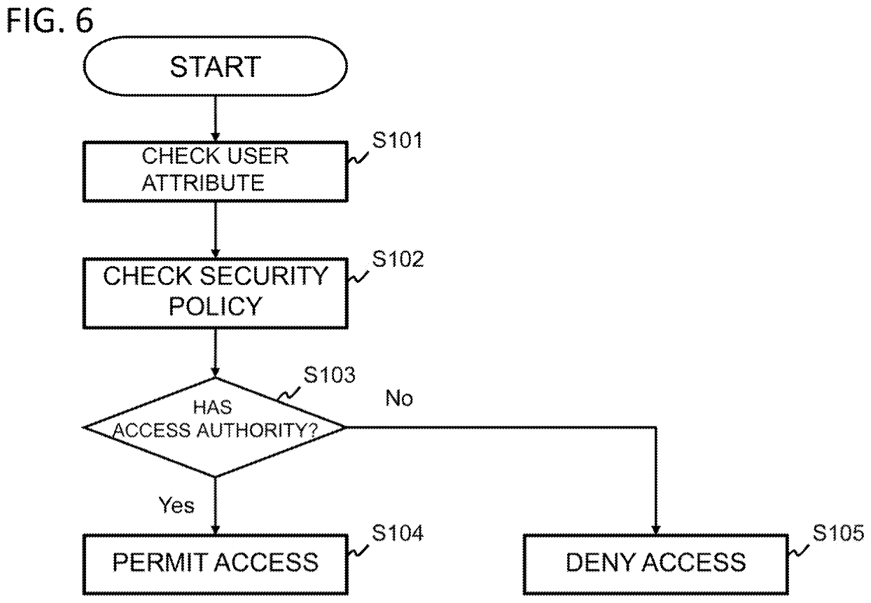

Next, an operation of the information processing system 200, when it receives access from a user terminal, will be described. FIG. 6 is a flowchart showing an operation (access control) of the information processing system 200 when it receives a viewing request of image data from a user terminal. Referring to FIG. 6, the information processing system 200 first checks a user attribute using a user ID and other information included in the viewing request of image data received from the user terminal (step S101). For example, the user attribute can be checked by referring to a table in which a user ID is associated with a user attribute in advance or can be determined from user attribute information embedded in a particular part of the user ID. It goes without saying that a method whereby the information processing system 200 can also inquire an external server or the like about the user attribute using the user ID can also be adopted.

Next, the information processing system 200 checks the security policy and confirms whether or not a user with the relevant user attribute has access authority for the event type of image data for which the viewing request was received (steps S102 and S103). If, as a result of the above confirmation, it is confirmed that the user terminal has access right to the relevant image data, the information processing system 200 permits the user terminal to access the relevant image data (step S104). On the other hand, if it cannot be confirmed that the user terminal has access right to the relevant image data, the information processing system 200 denies the user terminal to access the relevant image data (step S105).

As explained above, the information processing system 200 of the present example embodiment analyses the image data captured by the cameras 100A to 100N, identifies the event type and stores the image data in the data storage part 203. The information processing system 200 then performs appropriate access control to the user terminal with reference to the security policy.

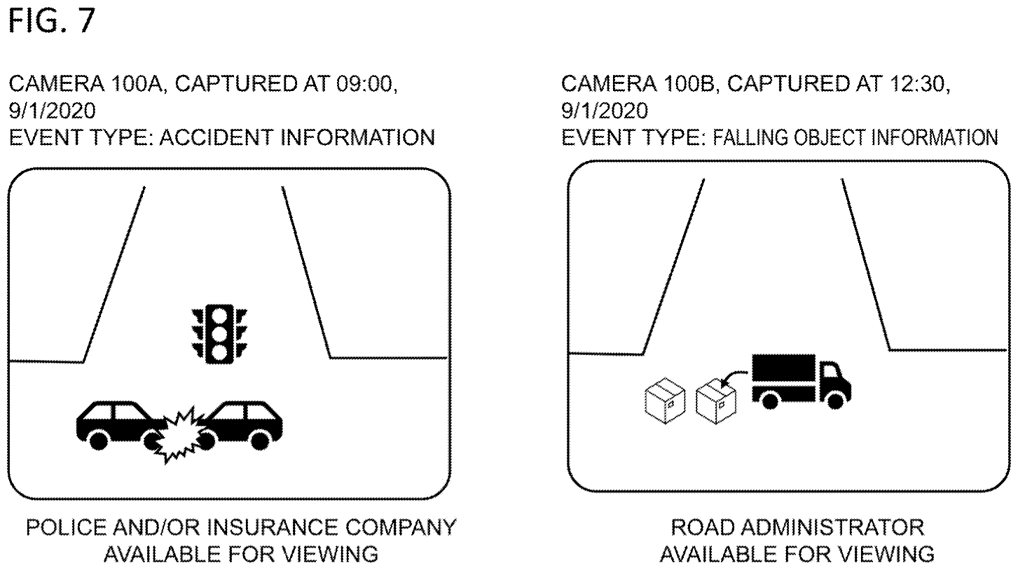

FIG. 7 is a drawing illustrating an example of the access control performed by the information processing system 200. For example, the information processing system 200 analyzes image data (the drawing on the left side of FIG. 7) captured by the camera 100A at 9 AM on Sep. 1, 2020, detects an occurrence of an accident, and stores the image data in the data storage part 203 with linking “accident information” as the event type. When the information processing system 200 receives an access request to this image data from a user terminal(s) of police and/or an insurance company, it permits access. On the other hand, when the information processing system 200 receives an access request to this image data from a user terminal of a road manager, it denies access.

Similarly, for example, the information processing system 200 analyzes image data (the drawing on the right side of FIG. 7) captured by the camera 100B at 12:30 PM on Sep. 1, 2020, detects a falling object, and stores the image data in the data storage part 203 with linking “falling object information” as the event type. When the information processing system 200 receives an access request to this image data from a user terminal of a road manager, it permits access. On the other hand, when the information processing system 200 receives an access request to this image data from a user terminal other than the road manager, it denies access.

As described above, the present example embodiment makes it possible to assign appropriate event types to a large number of images obtained by a plurality of cameras 100A to 100N and to perform access control appropriately. This makes operations of the police, insurance companies and road administrators more efficient. In addition, since the access control is performed on the basis of a security policy, it is possible to control a scope of disclosure so that privacy and security issues do not arise.

### Second Example Embodiment

Next, a second example embodiment of the present invention, in which an event type is determined using information from a plurality of sensors, will be described.

Since the second example embodiment can be achieved with the same configuration as that according to the first example embodiment, the second example embodiment will be described with a focus on the difference.

In the first example embodiment described above, the event type is determined from image data sent by a plurality of the cameras 100A to 100N. Meanwhile, the case is contemplated that it may be difficult to determine the event type only using information obtained from a single sensor (camera), depending on the event type. In the second example embodiment, contemplating such a case, the event analysis part 201 is made to detect an occurrence of a specific event using image data obtained from two or more cameras selected in advance among the cameras 100A to 100N.

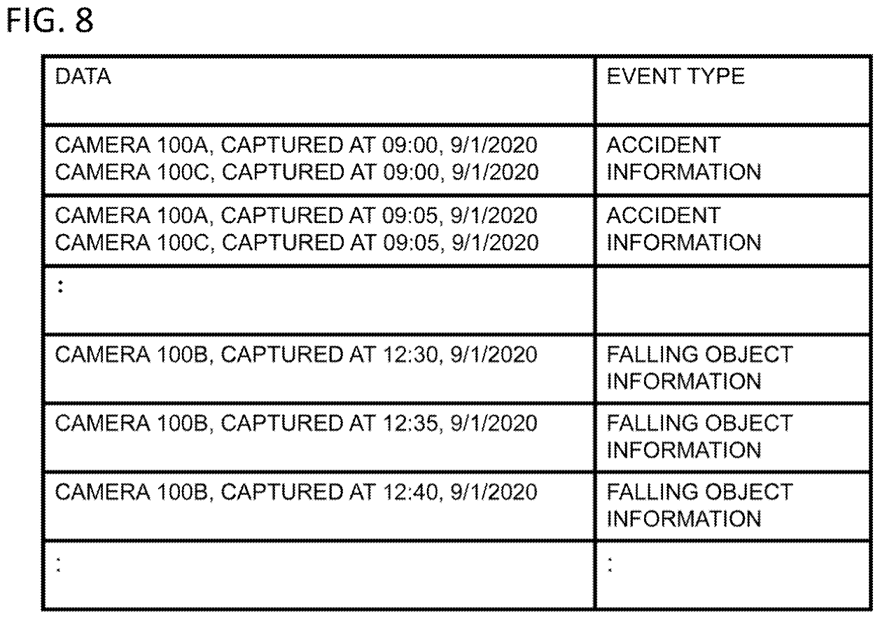

FIG. 8 is a drawing showing an example of data stored in the data storage part 203 of an information processing system according to the second example embodiment of the present invention. In the example of FIG. 8, the event analysis part 201 detects an occurrence of an event using a pair of the cameras 100A and 100C (not shown in FIG. 2) to determine a type thereof. The event analysis part 201 then stores these two pieces of image data in the data storage part 203 in association with each other.

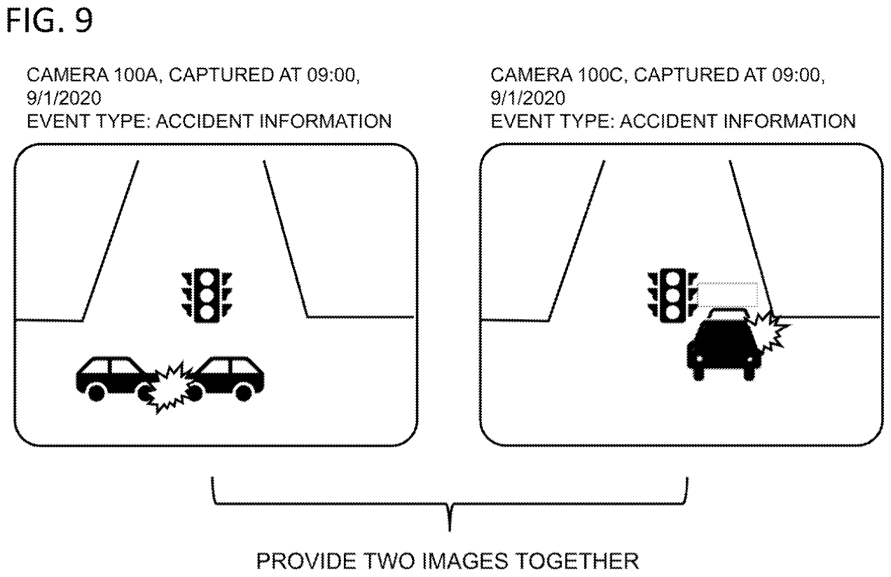

When access is received from a user terminal, the information processing system 200 of the present example embodiment can take a form to set these associated pieces of data as a pair and provide it to the user terminal. FIG. 9 is a drawing illustrating an example of how the information processing system of the present example embodiment provides data. In the example in FIG. 9, the information processing system detects events from images of cameras installed at different positions of an intersection and provides these images together. For example, it is difficult to determine from the image on the right side of FIG. 9 alone whether an accident has occurred or whether an accident could have been avoided immediately before, because vehicle images are overlapped in the image on the right side of FIG. 9. In the present example embodiment, events can be detected accurately because the image on the left side of FIG. 9 is also used to detect events. Furthermore, a user can also receive a set of images obtained from multiple viewpoints, which enables the user to understand a situation of the event (accident) accurately. In the above examples, images from a plurality of cameras were used to determine events, however, it is also possible to determine events using a pair of a camera and a non-camera sensor, or a pair of non-camera sensors. For example, it is possible to use a pair of a camera and an ultrasonic sensor or an infra-red sensor to accurately detect vehicle or person staying at a specific location as an event.

### Third Example Embodiment

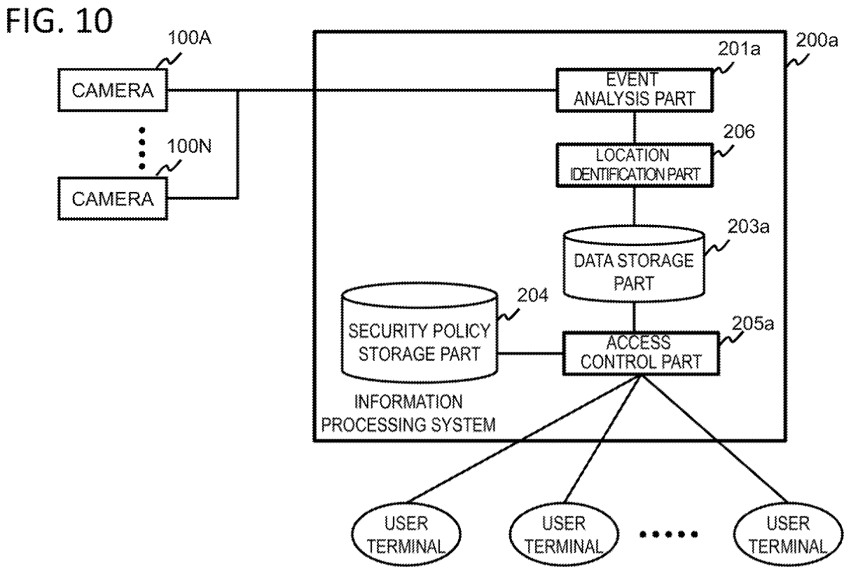

Next, a third example embodiment of the present invention, in which access control is performed taking into account a location of a sensor in addition to an event type, will be described. FIG. 10 is a drawing illustrating a configuration of an information processing system according to the third example embodiment of the present invention. A difference in configuration from the configuration of the first example embodiment shown in FIG. 2 is that a location identification part 206 is added between an event analysis part 201a and a data storage part 203a. Other configurations are almost the same as the configuration of the first example embodiment, so the following description will focus on the differences.

After detecting an event from an input data (e.g. image data), the event analysis part 201a outputs the input data (e.g. image data) to the location identification part 206.

The location identification part 206 identifies a location of a sensor (e.g. camera) from which the data (e.g. image data) input from the event analysis part 201a is transmitted. The location of the sensor (e.g. camera) can be identified, for example, from an ID of the sensor (e.g. camera) from which the data (e.g. image data) is transmitted. If location information such as Global Positioning System (GPS) or information on base stations or access points to which the sensor (e.g. camera) is connected is added to the data (e.g. image data), these information can also be used as location information. It goes without saying that these information may be inquired from an external server or the like.

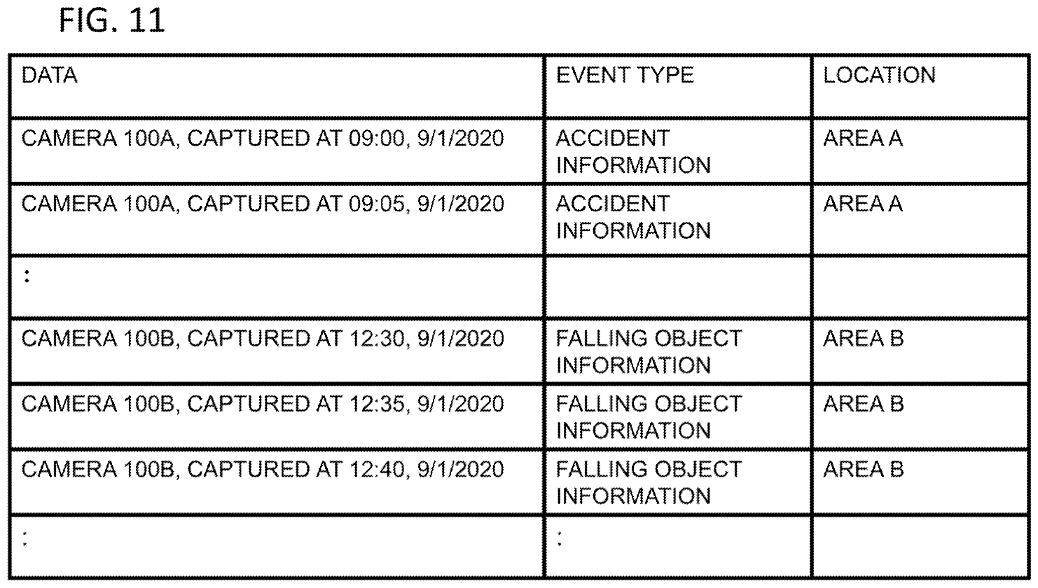

The location identification part 206 associates the data (e.g. image data) input from the event analysis part 201a with an event type and the location information and stores them in the data storage part 203a. FIG. 11 is a drawing showing an example of data stored in the data storage part 203a of the information processing system according to the third example embodiment of the present invention. In the example of FIG. 11, the location identification part 206 identifies an area where the sensor (e.g. camera) is installed as location information. The form of expression of location information is not limited thereto and may be expressed, for example, using latitude and longitude information, access point information, a name of road and/or facility where a sensor (e.g. cameras) is installed, etc.

An access control part 205a receives from a user terminal a viewing request specifying an event type for data (for example, image data) stored in the data storage part 203a. The access control part 205a then refers to the security policy and performs access control using the location information. Concretely, the access control part 205a determines whether or not the relevant user terminal has access right and whether or not a location of the relevant user terminal and the location information linked with the data (e.g. image data) match. If, as a result of the above determination, the user terminal has access right and the location of the relevant user terminal and the location information linked with the data (e.g. image data) match, the access control part 205a permits access to the requested data (e.g. image data). The location of the user terminal can also be ascertained from location information such as GPS and/or information on base stations and/or access points to which the user terminal is connected. Other methods can be used, for example, by referring to a table that maps a user ID to a user location in advance, or by using location information of user embedded in a specific part of the user ID. It goes without saying that the access control part 205a can also inquire an external server or the like for the location of the user terminal.

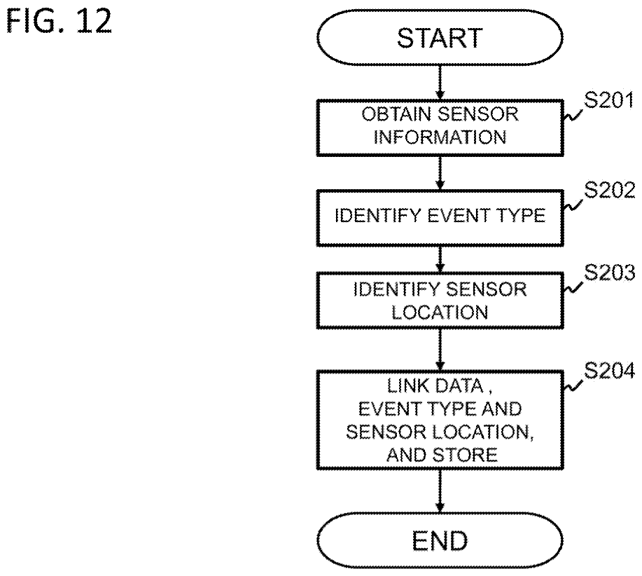

Next, an operation of the present example embodiment will be described in detail with reference to the drawings. FIG. 12 is a flowchart showing an operation (data storage) of the information processing system according to the present example embodiment. With reference to FIG. 12, when the information processing system 200a obtains image data from one of the cameras 100A to 100N as sensor information (step S201), it analyzes the image data and identifies a type of an event that has occurred (step S202). Further, the information processing system 200a then identifies a location of the sensor (camera) corresponding to the image data (step S203).

Finally, the information processing system 200a links the image data, the event type and the location information and stores them in the data storage part 203a (step S204). By repeating the above operations, data, each which is linked to an event type and location information, are accumulated in the data storage part 203a, as shown in FIG. 11.

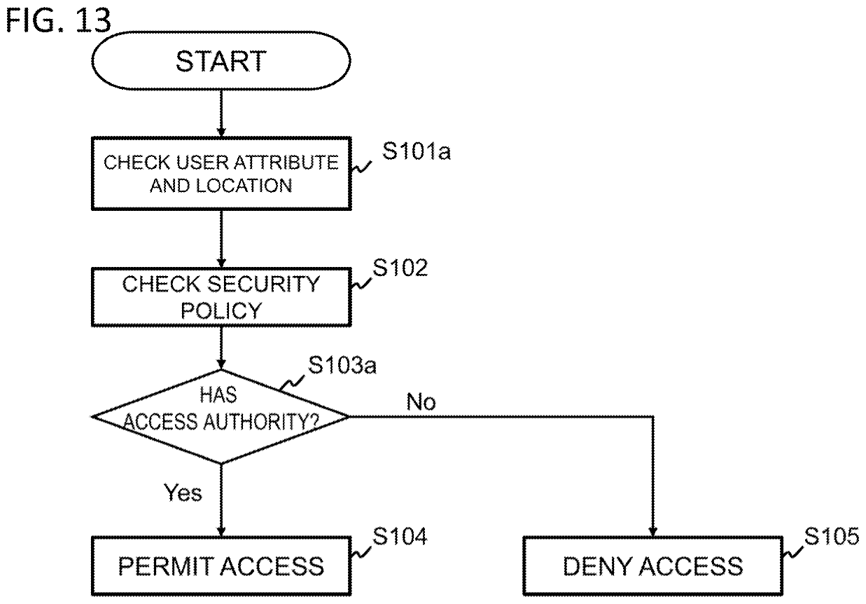

Next, an operation of the information processing system 200a, when it receives access from a user terminal, will be described. FIG. 13 is a flowchart showing an operation (access control) of the information processing system 200a when it receives a viewing request of image data from a user terminal. Referring to FIG. 13, the information processing system 200a first checks an attribute and a location of a user from a user ID and other information included in the viewing request of the image data received from the user terminal (step S101a).

Next, the information processing system 200a checks the security policy and confirms whether or not the user with the relevant user attribute has an access authority for the event type of image data for which the viewing request was received (steps S102 and S103a). If, as a result of the above confirmation, it is confirmed that the user terminal has an access right to the relevant image data and is located in an area in the vicinity where the image data was captured, the information processing system 200a permits the user terminal to access the relevant image data (step S104). On the other hand, if it cannot be confirmed that the user terminal has access right to the relevant image data, the information processing system 200a denies the user terminal to access the relevant image data (step S105). Even if it can be confirmed that the user terminal has access right to the relevant image data, the information processing system 200a also denies access to the relevant image data in case where the location of the user terminal is outside the area in the vicinity where the image data was captured (step S105).

According to the present example embodiment, which operates as described above, in addition to access control by security policy, it is possible to perform access control in terms of whether or not the user terminal is located in the vicinity of the sensor (e.g. camera) from which the image data is transmitted. In this way, it is possible to allow access to data (e.g. image data) set the event type of “accident information” only to the police in that jurisdiction. The same applies to falling object information, where access can only be allowed to the municipality or prefecture that is the road administrator of the road on which the object has fallen.

In the example embodiments described above, access control is performed based on whether or not the user terminal is located in the area in the vicinity where the data (e.g. image data) was captured, but a form of control using a security policy that specifies location information in detail in addition to a user attribute can also be adopted. This enables more detailed access control. For example, for the police, an accessibility decision can be made on a first geographical condition of whether or not a user terminal belongs to a first area, while for an insurance company, an accessibility decision can be made on a second geographical condition, which is different from the first geographical condition. It is also possible to adopt a form of determining whether data (image data) is accessible or not based on a history of past locations of the user terminal as well as the current location thereof. In this way, for example, when an event (e.g. an accident) is detected, it is possible to publish the image only to users who may have witnessed the accident and to collect witnesses information.

### Fourth Example Embodiment

Next, a fourth example embodiment of the present invention, in which access control is performed according to a time range set for each user attribute in addition to a user attribute, will be described. Since the fourth example embodiment can be achieved with the same configuration as that according to the first example embodiment, the fourth example embodiment will be described with a focus on the difference.

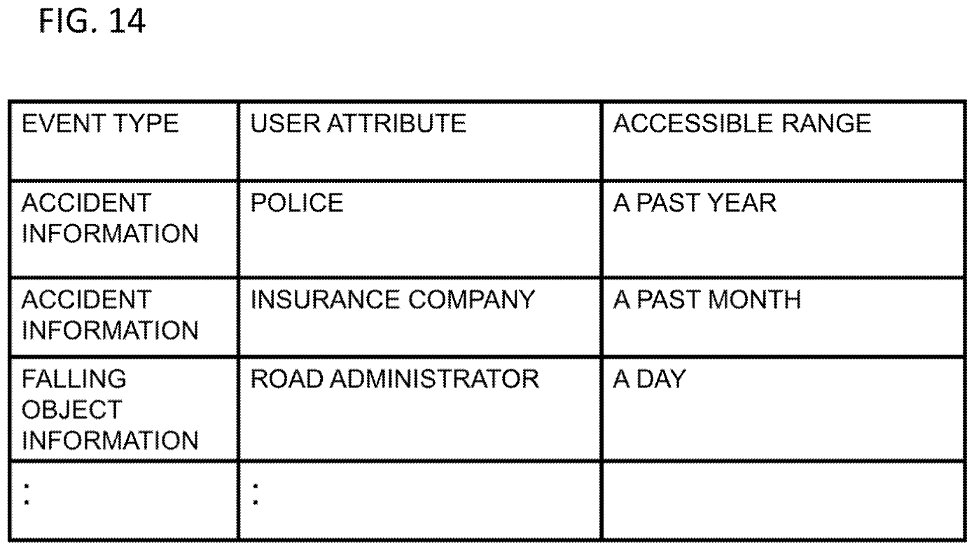

FIG. 14 is a drawing showing an example of a security policy used in the fourth example embodiment of the present invention. The difference from the security policy of the first embodiment shown in FIG. 4 is that the security policy has an accessible range indicating a time range accessible for each user attribute.

When an access request for data is received from a user terminal, the access control part 205 of the present example embodiment refers to the security policy and performs access control by the accessible range in addition to whether or not the user terminal has access right. Concretely, the access control part 205 permits access, if a storage date and time of an image data for which an access request has been received is within the period defined in the accessible range of the security policy. On the other hand, the access control part 205 denies access, if the storage date and time of the image data for which an access request has been received exceeds the period defined in the accessible range of the security policy.

According to the present example embodiment, which operates as described above, it is possible to perform access control by changing a time range of accessible data for each user attribute. This allows, for example, as shown in FIG. 14, access to image data of accident information for a past year to be granted to the police, while access from an insurance company can be restricted to image data of accident information for a past month.

The same control as in the present example embodiment may also be performed when providing the user terminal with a search function for image data stored in the data storage part 203. In this way, it is possible to have differences in the time range of data output as search results according to user attributes. For example, the difference can be made so that when a police officer searches for accident information, image data for the past year is output as a search result, whereas when an insurance company employee searches for image data under the same conditions, only image data for the past month is output as a search result.

### Fifth Example Embodiment

Next, a fifth example embodiment of the present invention, in which access control is performed according to a spatial range set for each user attribute in addition to an user attribute, will be described. FIG. is a drawing illustrating a configuration of an information processing system according to the fifth example embodiment of the present invention. A difference in configuration from the configuration of the first embodiment shown in FIG. 2 is that a data division part 207 is added between an event analysis part 201b and a data storage part 203b. Other configurations are almost the same as the configuration of the first example embodiment, so the following description will focus on the differences.

After detecting an event from an input data, the event analysis part 201b outputs the input data to the data division part 207.

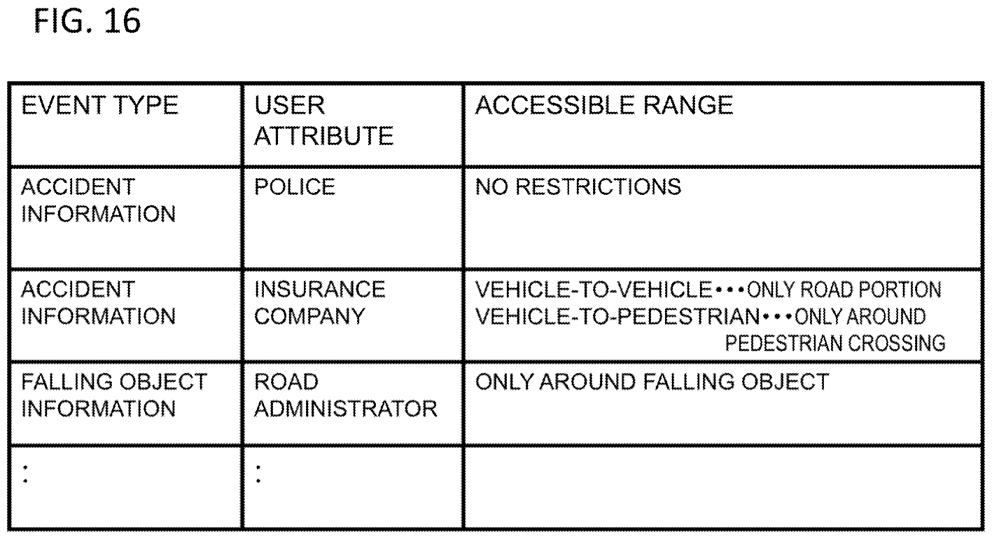

The data division part 207 divides the image data input from the event analysis part 201b with reference to the security policy. FIG. 16 is a drawing showing an example of a security policy used in the fifth example embodiment. The difference from the security policy of the first embodiment shown in FIG. 4 is that the security policy has an accessible range indicating a range of accessible images for each user attribute. For example, with regard to accident information, police and an insurance company each have access right, but the range of accessible images is different. In this case, the data division part 207 creates image data for the police and image data for the insurance company with limiting accessible range, links the event type of “accident information” to each and stores them in the data storage part 203b.

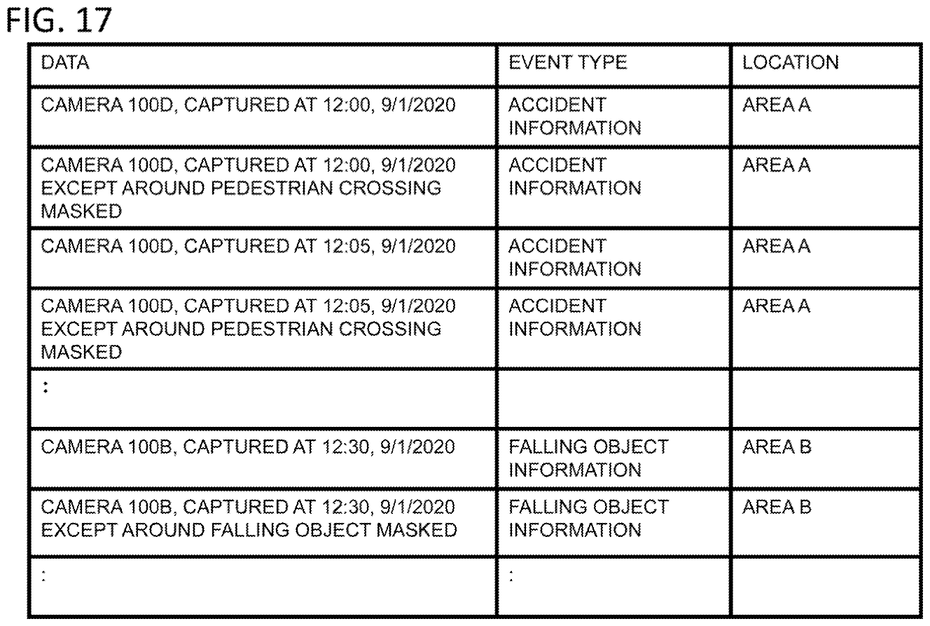

FIG. 17 is a drawing showing an example of data stored in the data storage part 203b of the information processing system according to the fifth example embodiment of the present invention. In the example in FIG. 17, an image data of “camera 100D, shooting time 2020/9/1 12:00-12:05, and event type=“accident information— is divided into original image data (lines 1 and 3 from the top) as well as image data with an area except around a pedestrian crossing masked (lines 2 and 4 from the top). Similarly, an image data of “camera 100B, shooting time 2020/9/1 12:30, and event type=“falling object information”” is divided into an original image data as well as an image data with an area except around the falling object masked.

The access control part 205b receives from a user terminal a viewing request specifying an event type for data stored in the data storage part 203b. The access control part 205b then refers to the security policy to check whether or not the relevant user terminal has access right, and then performs access control to the image data corresponding to the accessible range of the relevant user terminal.

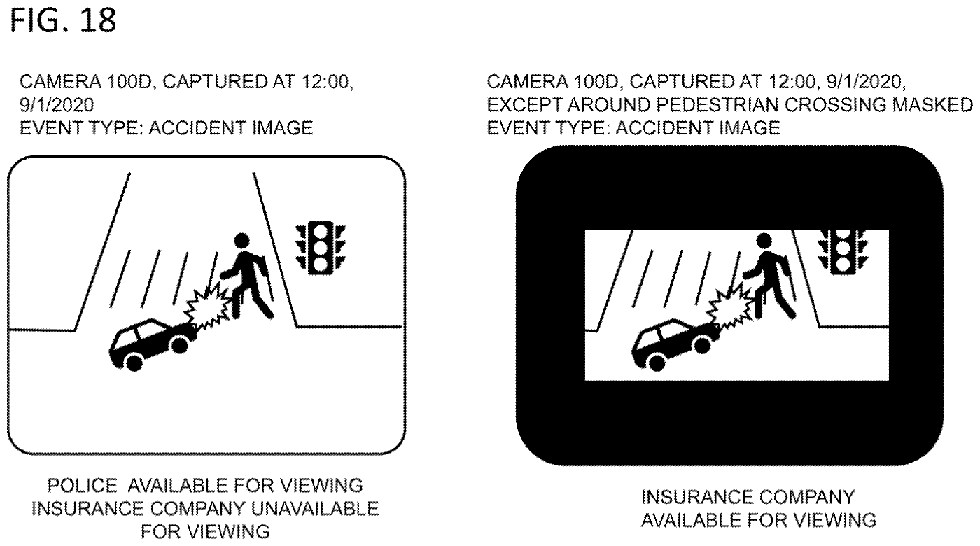

According to the present example embodiment, which operates as described above, it is possible to perform access control by changing a spatial range of accessible data for each user attribute. This allows, for example, as shown in FIG. 18, access to an original image data to be granted to the police, while access from an insurance company can be restricted to image data with an area except around a pedestrian crossing masked. This makes it possible to avoid the privacy and security issues for people or others who happen to appear in the image data.

### Sixth Example Embodiment

Next, a sixth example embodiment of the present invention, in which functions that can be applied to image data can be changed for each user attribute, will be described. Since the sixth example embodiment can be achieved with the same configuration as that according to the first example embodiment, the sixth example embodiment will be described with a focus on the difference.

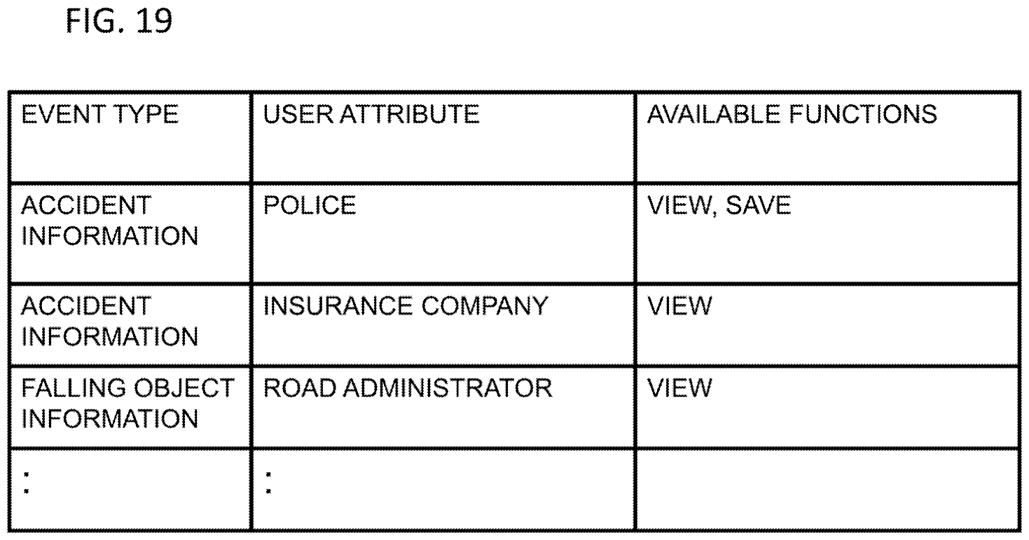

FIG. 19 is a drawing showing an example of a security policy used in the sixth example embodiment of the present invention. The difference from the security policy of the first example embodiment shown in FIG. 4 is that the security policy has an available function(s) (functional restriction information) for each user attribute.

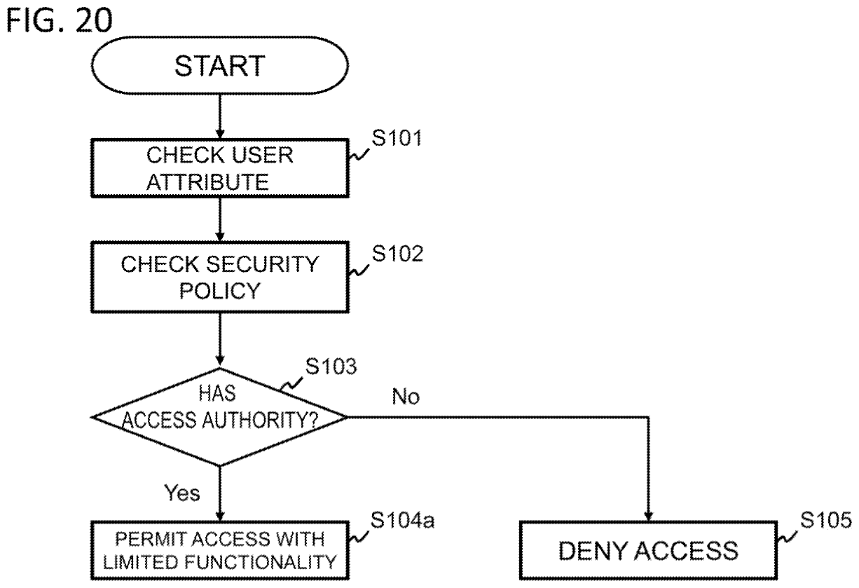

Next, an operation of the information processing system 200 of the present example embodiment, when it receives access from a user terminal, will be described. FIG. 20 is a flowchart showing an operation (access control) of the information processing system 200 when it receives a viewing request of image data from a user terminal. Since the operations of the steps S101 to S103 in FIG. 20 are the same as those in the first example embodiment, the description thereof will be omitted.

Depending on a result of checking the security policy in step S103, the information processing system 200 performs the following operations. First, if it is confirmed that the user terminal has access right to the relevant image data, the information processing system 200 permits the user terminal to access the relevant image data by limiting to available function(s) as defined in the security policy (step S104a). For example, if the attribute of the user terminal is ‘POLICE’, the information processing system 200 allows the user terminal to view as well as to store image data whose event type is accident information. For example, if the attribute of the user terminal is ‘INSURANCE COMPANY’, the information processing system 200 only allows the user terminal to view image data whose event type is accident information.

If it cannot be confirmed that the user terminal has access right to the relevant image data, the information processing system 200 denies the user terminal to access the relevant image data, as in the first embodiment (step S105).

As described, according to the information processing system 200 of the present example embodiment, it becomes possible to change the functions that can be applied to image data for each user attribute. Although the above mentioned examples of viewing and storing image data were given as functions to be assigned to each user attribute in the example embodiments described above, the functions to be assigned to each user attribute are not limited to these examples. For example, authorizations for zooming, editing and emailing image data may be granted for each user attribute. The functions to be granted to each user attribute are not limited to those targeting image data but may also include content that can be instructed to a transmission source of sensor data. For example, authorization may be granted for operating etc., a sensor (camera) from which image data is transmitted and its attached equipment. For example, a police officer may be authorized to pan, tilt and zoom the camera. Further, when an accident is detected, a police officer may be authorized to control traffic lights attached to a camera.

While each example embodiment of the present invention has been described, it is to be understood that the present invention is not limited to the example embodiments above and that further modifications, replacements, or adjustments can be made without departing from the basic technical concept of the present invention. For example, the configuration of network, the configuration of each element, and the expression of the data shown in each drawing are examples to facilitate understanding of the present invention and the present invention is not limited to the configurations shown in the drawings.

For example, in each of the above example embodiments, image data (still images) captured by cameras 100A to 100N were described as being handled, but sensor data to which the present invention can be applied is not limited to image data. For example, image data may be video. In this case, the event analysis part 201 may identify an event in video data using scene analysis technology. The linking of event information in the data storage part can be achieved by tagging to the video.

In the example embodiments described above, examples of accidents and falling objects were given as events to be detected from image data, but the types of events are not limited to these examples. For example, accident event, notification to a road administrator detection event, notified object for a passing vehicle detection event, traffic violation detection event, and person detection event may be set as appropriate. Furthermore, detection of vehicles and/or pedestrians in positions that are in a blind spot from vehicles travelling in the vicinity may be considered as an event. In this case, an in-vehicle terminal of the vehicle in which the blind spot in question occurs can be used as a user terminal to which access is permitted, thereby helping to prevent accidents. For example, wetness of a road surface as captured by the camera may be detected as an event. By setting an appropriate security policy, image data of such a wet road surface can be provided to a user who wants to know an amount of precipitation at the location captured by the camera.

In the example embodiments described above, an example of a plurality of cameras 100A to 100N installed on the roadside and connected as sensors is described, but the same can be applied to image data captured by security cameras, street cameras and other cameras. Moreover, the sensors are not limited to cameras and may be various measuring devices or IoT (Internet of Things) devices. For example, a detection of temperatures exceeding a predetermined value in thermometers installed throughout the city may be detected as an event. By setting appropriate security policies, such thermometer data can be provided to a user who wants to know distributions of temperatures in different locations.

It can also be applied, for example, in applications such as for a tourism industry, where congestion events are determined based on image data, etc. obtained from sensors (cameras) and appropriate access rights are given to general users and tourist agents. In this case, the information processing system 200 performs congestion estimation of facilities and tourist spots based on image data and/or people flow data, etc., obtained from sensors (cameras), and determines events (congestion small, . . . , congestion large) according to congestion level. A security policy could be to make images available to general users after anonymisation, regardless of the level of congestion, and to grant access rights to image data to tourist agents and/or security personnel, depending on the level of congestion. Further, the security policy may be used to change who can access image data depending on the level of congestion. The contents of the security policy may also be changed according to the type of facility and/or tourist spot. For example, in a case of open areas such as beaches, access may be allowed to a wide range of general users, while in closed areas such as inside facilities and/or stations, access may be allowed only to the operator of the facility and/or station in question, or to tourist agents in partnership with the operator. In this way, it is possible to inform the general users about the level of congestion in places they want to visit. In addition, tourist agents and others can improve user satisfaction at the destination by levelling congestion levels, for example, by guiding users to relatively empty facilities instead of crowded ones.

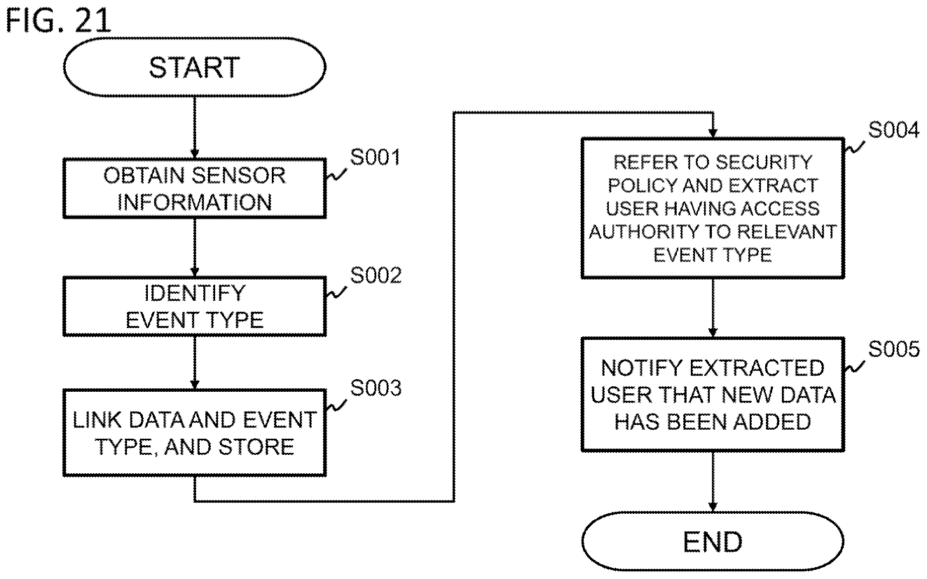

In the example embodiments described above, a user (user terminal) is described as actively accessing the information processing system, but the information processing system may also notify the user (user terminal) that accessible data has been added and encourage access. For example, this function can be added by providing a push notification function to the access control part 205 of the information processing system according to the first example embodiment (a seventh example embodiment). In this case, as shown in FIG. 21, after the processes of the steps S001 to S003 in FIG. 5, the access control part 205 refers to the security policy and extracts a user having access authority to each relevant event type (step S004). Then, the access control part 205 notifies the extracted user via email or postings on an SNS (Social Networking Service) that new data has been added (step S005). For example, if image data whose event type is accident information is newly added, the information processing system 200 notifies police and an insurance company that image data whose event type is accident information has been newly added. This makes it possible to have police officers and insurance company employees to access the image data as soon as possible.

In the above-mentioned embodiments, the security policy is described as primarily used for performing access control, but instead of access control, the security policy may be set to specify whether or not data is to be anonymised according to event type, etc., and the contents of such anonymisation process. In this way, it is possible to change the level of disclosure according to user attributes and according to the content of the images, such as traffic accidents and videos of the moment of the accident, while granting uniform access right to a certain range.

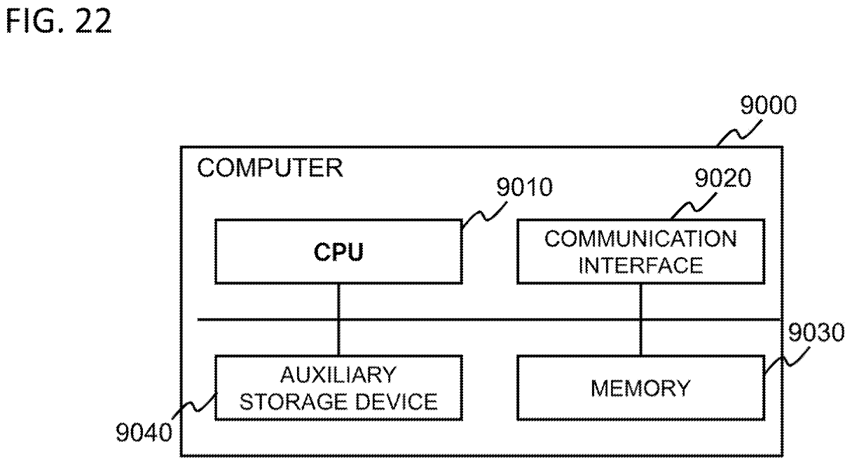

Further, the procedures described in the first to the seventh example embodiments above can be implemented by a program causing a computer (9000 in FIG. 22) that functions as the information processing system 200 to realize the functions of the information processing system 200. FIG. 22 illustrates such a computer configured to comprise a CPU (Central Processing Unit) 9010, a communication interface 9020, a memory 9030, and an auxiliary storage device 9040. In other words, the CPU 9010 in FIG. 22 executes an event detection program and an access control program, updating each computation parameter held by the auxiliary storage device 9040.

In other words, each part (each processing means or function) of the information processing system 200 described in each example embodiment above can be realized by a computer program causing a processor installed in the information processing system 200 to execute each of the processes described above using the hardware thereof.

Finally, preferred modes of the present invention will be summarized.

### [Mode 1]

(Refer to the information processing system according to the first aspect.)

### [Mode 2]

The information processing system may be configured to control whether or not the access is permitted on a basis of a location where the data measured by the sensor is obtained and a location of a user, in addition to the security policy.

### [Mode 3]

Sensor data handled by the information processing system may include data recorded at a predetermined time interval, and the security policy may further include information specifying a time range during which a user is able to access a sensor data.

### [Mode 4]

Sensor data handled by the information processing system may include image data, and the security policy may further include information specifying a range on image of image data to which the user is able to access.

### [Mode 5]

The security policy held by the information processing system may include functionality restriction information indicating a function that the user is able to apply to sensor data.

### [Mode 6]

The security policy held by the information processing system may include a content that allows the user to instruct a transmission source of the sensor data.

### [Mode 7]

The sensor data handled by the information processing system may be traffic-related data measured by a sensor installed in a transportation infrastructure.

### [Mode 8]

The information processing system may further comprise a function to notify a user having an access right to a relevant data by referring to the security policy upon detecting an occurrence of a new event.

### [Mode 9]

The type of an event detected by the information processing system may be any of an accident event, a notification to a road administrator detection event, a notified object for a passing vehicle detection event, a traffic violation detection event, and a person detection event.

### [Mode 10]

(Refer to the information processing method according to the second aspect.)

### [Mode 11]

(Refer to the computer program according to the third aspect.)

The above modes 10 and 11 can be expanded in the same way as mode 1 is expanded to modes 2 to 9.

The disclosure of each Patent Literature cited above is incorporated herein in its entirety by reference thereto and can be used as a basis or a part of the present invention as needed. It is to be noted that it is possible to modify or adjust the example embodiments or examples within the scope of the whole disclosure of the present invention (including the Claims) and based on the basic technical concept thereof. Further, it is possible to variously combine or select (or partially omit) a wide variety of the disclosed elements (including the individual elements of the individual claims, the individual elements of the individual example embodiments or examples, and the individual elements of the individual figures) within the scope of the disclosure of the present invention. That is, it is self-explanatory that the present invention includes any types of variations and modifications to be done by a skilled person according to the whole disclosure including the Claims and the technical concept of the present invention. Particularly, any numerical ranges disclosed herein should be interpreted that any intermediate values or subranges falling within the disclosed ranges are also concretely disclosed even without specific recital thereof. In addition, as needed and based on the gist of the present invention, partial or entire use of the individual disclosed matters in the above literatures that have been referred to in combination with what is disclosed in the present application should be deemed to be included in what is disclosed in the present application, as a part of the disclosure of the present invention.

### REFERENCE SIGNS LIST

10: sensor
20, 200, 200a, 200b: information processing system
21: data input part
24, 204, 204b: security policy storage part
25, 205, 205a, 205b: access control part
30: data storage part
100A to 100N: camera
201, 201a, 201b: event analysis part
203, 203a, 203b: data storage part
206: location identification part
207: data division part
9000: computer
9010: CPU
9020: communication interface
9030: memory
9040: auxiliary storage device

What is claimed is:

1. An information processing system, comprising:
at least a processor and
a memory in circuit communication with the processor,
wherein the processor is configured to execute program instructions stored in the memory to perform,
detecting an occurrence of an event on a basis of data measured by a predetermined sensor;
and
controlling whether or not an access from a user to data on which the event is occurring is permitted on a basis of a security policy stored in a storage, the security policy defining a user attribute allowed to access to each type of the event.

2. The information processing system according to claim 1, wherein
the processor is further configured to execute program instructions stored in the memory to perform controlling whether or not the access is permitted on a basis of a location where the data measured by the sensor is obtained and a location of a user, in addition to the security policy.

3. The information processing system according to claim 1, wherein
the data measured by the sensor includes data recorded at a predetermined time interval, and
the security policy further includes information specifying a time range during which a user is able to access a sensor data.

4. The information processing system according to claim 1, wherein
the data measured by the sensor includes image data, and
the security policy further includes information specifying a range on image of image data to which the user is able to access.

5. The information processing system according to claim 1, wherein
the security policy includes functionality restriction information indicating a function that the user is able to apply to the data measured by the sensor.

6. The information processing system according to claim 1, wherein
the security policy includes a content that allows the user to instruct a transmission source of the data measured by the sensor.

7. The information processing system according to claim 1, wherein
the data measured by the sensor is traffic-related data measured by a sensor installed in a transportation infrastructure.

8. The information processing system according to claim 1,
wherein
the processor is further configured to execute program instructions stored in the memory to perform notifying a user having an access right to a relevant data by referring to the security policy upon detecting an occurrence of a new event.

9. An information processing method of an information processing system including a security policy storage part storing a security policy that defines a user attribute allowed to access to each type of an event and a control part, the information processing method, comprising:
detecting an occurrence of the event on a basis of data measured by a predetermined sensor; and
controlling whether or not an access from a user to data on which the event is occurring is permitted on a basis of the security policy.

10. A non-transitory computer-readable medium storing a program causing a computer comprising a security policy storage part storing a security policy that defines a user attribute allowed to access to each type of an event and a control part to execute:
a process of detecting an occurrence of the event on a basis of data measured by a predetermined sensor; and
a process of controlling whether or not an access from a user to data on which the event is occurring is permitted on a basis of the security policy.

11. The information processing system according to claim 2, wherein
the data measured by the sensor includes data recorded at a predetermined time interval, and
the security policy further includes information specifying a time range during which a user is able to access a sensor data.

12. The information processing system according to claim 2, wherein
the data measured by the sensor includes image data, and
the security policy further includes information specifying a range on image of image data to which the user is able to access.

13. The information processing system according to claim 3, wherein
the data measured by the sensor includes image data, and
the security policy further includes information specifying a range on image of image data to which the user is able to access.

14. The information processing system according to claim 2, wherein
the security policy includes functionality restriction information indicating a function that the user is able to apply to the data measured by the sensor.

15. The information processing system according to claim 3, wherein
the security policy includes functionality restriction information indicating a function that the user is able to apply to the data measured by the sensor.

16. The information processing system according to claim 4, wherein
the security policy includes functionality restriction information indicating a function that the user is able to apply to the data measured by the sensor.

17. The information processing system according to claim 2, wherein
the security policy includes a content that allows the user to instruct a transmission source of the data measured by the sensor.

18. The information processing system according to claim 3, wherein
the security policy includes a content that allows the user to instruct a transmission source of the data measured by the sensor.

19. The information processing system according to claim 4, wherein
the security policy includes a content that allows the user to instruct a transmission source of the data measured by the sensor.

20. The information processing system according to claim 5, wherein
the security policy includes a content that allows the user to instruct a transmission source of the data measured by the sensor.
